(19) United States
(12) Patent Application Publication
(10) Pub. No.: US 2009/0155536 A1
(43) Pub. Date: Jun. 18, 2009

(54) Printed Mat

(76) Inventor: Charles Chang, Taichung (TW)

Correspondence Address: ST. ONGE STEWARD JOHNSTON & REENS, LLC, 986 BEDFORD STREET, STAMFORD, CT, 06905-5619, US

(21) Appl. No.: 12/338,557

(22) Filed: Dec. 18, 2008

Related U.S. Application Data
(60) Provisional application No. 61/014,585, filed on Dec. 18, 2007.

(51) Int. Cl. B32B 5/18; B32B 3/10; B32B 38/14

(52) U.S. Cl. 428/158; 428/195.1; 428/172; 156/235

(57) ABSTRACT

A floor mat is provided having a top layer made with polyester felt capable of receiving printing by sublimation printing techniques, a bottom layer made with latex foam, and an adhesive layer between the top and bottom layers. The top layer includes a four color process printing applied thereon by sublimation of sublimation inks. The floor mat may further include a middle layer made with foam to provide extra cushioning for the floor mat.

### CROSS-REFERENCE TO RELATED APPLICATIONS

The present application claims the benefit under 35 U.S.C. §119(e) of the U.S. Provisional Patent Application Ser. No. 61/014,585, filed on Dec. 18, 2007, the content of which is incorporated herein by reference.

### FIELD OF THE INVENTION

The present invention relates to a floor mat, and more specifically to a floor mat with high quality printing.

### BACKGROUND OF THE INVENTION

Floor mats are known for cleaning the soles of a person's shoes who is about to enter a home, business, a particular area, or a room. Floor mats are also used in various rooms inside a house, such as a bathroom, to wipe the person's feet after a shower or to provide a comfortable cushioned surface for the person to step on. Conventional floor mats often include a bottom portion made of a resilient material for contacting the floor and prevent slippage of the mat. Some floor mats also include an absorbent top layer for absorbing rain water or snow.

Floor mats may have any number of shapes, sizes and appearances. Some floor mats include decorative designs, patterns or images on the top layer. However, there is a desire in the art for floor mats with high quality images or illustrations.

The process of applying brilliantly colored images to some items, such as towels, is known from U.S. Pat. No. 5,486,500 to Kaufman. U.S. Pat. No. 5,486,500 discloses a process for producing a printed towel capable of four color process photo reproduction printing. However, such a process has not been adapted for use on floor mats.

Therefore, what is desired is an improved floor mat including high quality images printed on at least one face of the mat.

### SUMMARY OF THE INVENTION

To achieve at least the above objects of the present invention, a floor mat is provided having a top layer made with a material capable of receiving printing by sublimation printing techniques, a bottom layer having a floor-contacting surface that resists axial movement of the floor mat on a floor surface, and at least one adhesive layer between the top and bottom layers, wherein the top layer includes a four color process printing applied thereon by sublimation of sublimation inks.

In some embodiments, the top layer of the floor mat may be made with a polyester felt material. In some embodiments, the bottom layer of the floor mat may be made with a latex foam material.

In certain embodiments, the bottom layer may further include a plurality of ridges disposed throughout the floor-contacting surface of the bottom layer to prevent slippage of the floor mat with respect to the floor. In some embodiments, the bottom layer may comprise a material having a coefficient of friction that resists the axial movement of the floor mat on the floor surface

In some embodiments, the printing may be performed using photographic or lithographic techniques, and may include images, lettering or combinations thereof. In certain embodiments, the printing may be produced full bleed.

In certain embodiments, the floor mat may further include an absorbent middle layer placed between the top and bottom layers, and may further include a second adhesive layer, wherein the at least one adhesive layer adheres the top layer to the middle layer and the second adhesive layer adheres the middle layer to the bottom layer.

The foregoing objects are also achieved by provision of another embodiment of the present invention, comprising a floor mat having a top layer made with a material capable of receiving printing by sublimation printing techniques, at least one middle layer made with an absorbent foam material, a bottom layer made with a rubber material, and an adhesive layer between the top and the middle layers and between the middle and the bottom layers, wherein the top layer includes a four color process printing applied thereon by sublimation of sublimation inks.

In some embodiments, the bottom layer may further comprise a plurality of ridges disposed throughout the floor-contacting surface of the bottom layer to prevent slippage of the floor mat with respect to the floor.

In certain embodiments, the middle layer includes an open-celled polymeric foam material, and the top layer includes a polyester felt material.

In some embodiments, the printing is performed using photographic or lithographic techniques. In certain embodiments, the printing includes images, lettering or combinations thereof and is produced full bleed.

In yet another embodiment of the present invention, a method for manufacturing a floor mat is provided, including the steps of providing a top layer made with a material capable of receiving printing by sublimation printing techniques, printing an image on a backing sheet using sublimation inks, transferring the printed image from the backing sheet to the top layer by sublimation of the sublimation inks, and attaching the top layer to at least one bottom layer using an adhesive, wherein the bottom layer has a floor-contacting surface that resists axial movement of the floor mat on a floor surface.

In some embodiments, the method further includes a step of providing a plurality of ridges disposed throughout the floor-contacting surface of the bottom layer for resisting the axial movement of the floor mat on the floor surface.

In certain embodiments, the method further includes a step of attaching an absorbent middle layer to the top layer and the bottom layer using an adhesive.

In some embodiments, a slipping layer may be attached to a reverse side of the backing sheet to prevent sticking to a sublimation printing apparatus.

In some embodiments, the sublimation inks may be transferred to the printing receiving layer under heat and pressure. In certain embodiments, the printing may be performed using photographic or lithographic techniques and may include images, lettering or combinations thereof. In some embodiments, the printing may be produced full bleed.

Other objects of the invention and its particular features and advantages will become more apparent from consideration of the following drawings and accompanying detailed description.

### BRIEF DESCRIPTION OF THE DRAWINGS

FIG. 1 is a perspective view of the floor mat according to an exemplary embodiment of the present invention.

FIG. 2 is a cross-section view of the floor mat of FIG. 1.

FIG. 3 is a cross-section view of the floor mat according to another embodiment of the present invention.

### DETAILED DESCRIPTION OF THE INVENTION

The present invention relates to a floor mat having a high quality printed image thereon. The present invention employs a high quality printing process such as the process disclosed in commonly owned U.S. Pat. No. 5,486,500, incorporated herein by reference.

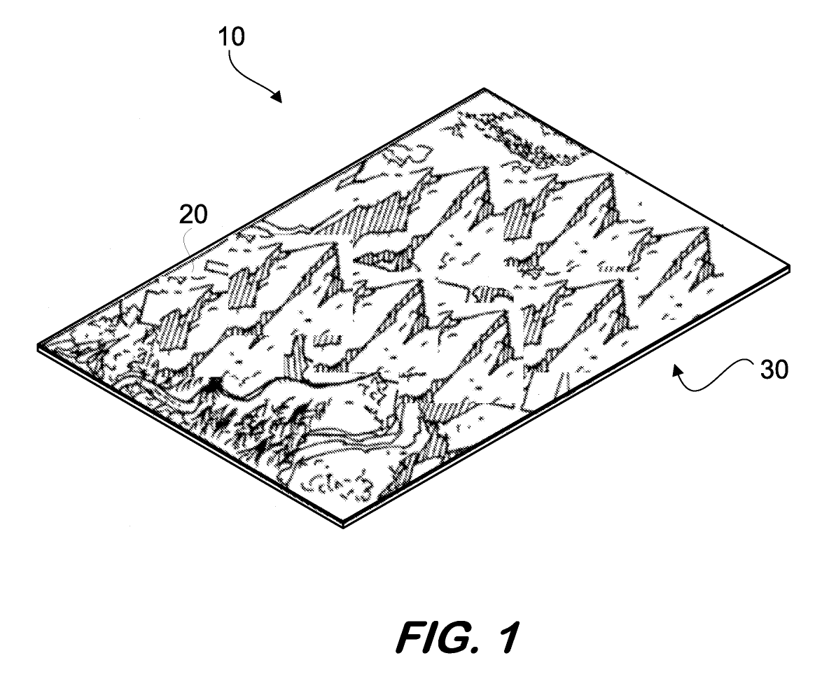

FIG. 1 illustrates an exemplary floor mat 10 according to the present invention. The floor mat 10 may be any suitable size. For example, in the present embodiment the floor mat 10 has a length between about 26 and 30 inches and a width of between about 16 and 20 inches. Although generally rectangular in shape, as illustrated in FIG. 1, floor mat 10 can also assume any desired shape. The floor mat 10 includes at least two layers 20 and 30. At least one of layers 20 and 30 of floor mat 10 of the present invention comprises a printing receiving layer or face.

Printing receiving layer 20 of floor mat 10 is comprised of a material capable of being dyed in a sublimation printing process. The layer 20 preferably also has a soft and comfortable texture. In a preferred embodiment, the layer 20 comprises a polyester felt material.

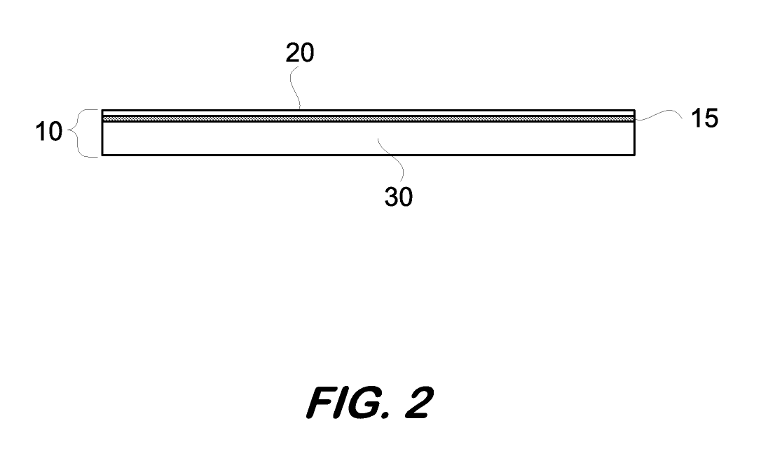

The layer 30 is adapted for contacting a floor surface and resisting movement of the floor mat 10 on the floor surface. For example, the layer 30 may be made with a material having a coefficient of friction that counteracts axial movement of the mat 10 on the floor. Such materials are known in the art and include materials such as rubber or latex foam. The layer 30 may also include a plurality of ridges arranged in various configurations throughout the bottom floor-contacting surface 50 of the layer 30, or other structures, such as suction cups, specially adapted for preventing slippage of the mat on the floor. The layer 30 may further provide cushion to the floor mat 10 for added comfort. In a preferred embodiment, the layer 30 is a foam layer comprising rubber latex. As illustrated in FIG. 2, the print receiving layer 20 is attached to the layer 30 by means of an adhesive layer.

Floor mat 10 can be formed with the printing receiving and/or absorbent materials in any desired color. However, it is preferred that the printing receiving layer 20 be either white or uncolored material so as to provide for the highest possible definition and brilliance of the printing applied thereto.

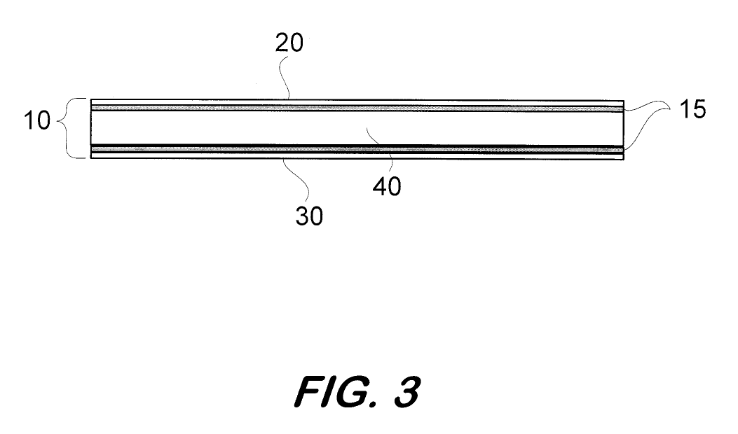

As shown in FIG. 3, the floor mat may also comprise a middle layer 40, positioned between the printing receiving layer 20 and the layer 30. The middle layer 40 is preferably comprised of a foam material capable of absorbing moisture from a person's shoes standing on the floor mat or from the person's feet after a shower or a bath. It is also possible to use the floor mat of the present invention as a kitchen mat, for example, for providing a surface to dry dishes on. The foam material can be open-cell polymeric foam, or any other type of foam known in the art that is capable of absorbing moisture. The middle layer 40 may also perform a cushioning function to add comfort to the person standing on the mat. The middle layer 40 is attached to the printing receiving layer 20 and the layer 30 using any suitable adhesive (adhesive layers 15).

Printing is applied to the printing receiving layer 20 by sublimation printing techniques. For example, the techniques taught in U.S. Pat. No. 5,486,500 may be used. The printing can be line art or four color process graphics including reproduction of photographs, lettering, images, or combinations thereof. Sublimation printing techniques involve the printing of a design on a paper backing sheet by conventional printing techniques. They employ sublimation inks which are then transferred under heat and pressure to printing receiving layer 20 of floor mat 10. Such techniques are described by DeVries and Snyder, in U.S. Pat. Nos. 4,021,591 and 4,058,644, the disclosures of each of which are incorporated herein by reference.

The backing sheet used for the sublimation printing of floor mat 10 can be formed of any material provided it is dimensionally stable and can withstand the heat of sublimation printing, which generally ranges between about 100 degrees (Celsius) and about 300 degree (Celsius). Suitable materials include polyesters such as polyethylene terephthalate, polyamides, polycarbonates, paper such as parchment, fiberglass cloth, a cross-linked phenol-formaldehyde resin, thin metal foil, woven or non-woven fabrics, cross-linked urea-formaldehyde resins, glassine paper, cellulose esters, fluorene polymers such as polyvinylidene fluoride or polytetrafluoroethylene, polyethers, polyolefins, polyacetals, and polyamides.

The backing sheet most often has a thickness between about 2 and about 30 microns and can also be coated with a subbing layer if desired. Moreover, the backing sheet can also include a slipping layer comprising a lubricating material on the reverse side of the printed side to prevent sticking to the sublimation printing apparatus.

The backing sheet has printing applied to it using sublimation inks. Such inks, although appearing somewhat dull and off-colored when printed on the backing sheet, produce brilliant and high definition designs when transferred to floor mat 10. The printing applied to the backing sheet can be any desired printing and can include four color photo reproductions. The inks used in applying the printing to the backing sheet for transfer to floor mat 10 comprise any sublimable dyes, including disperse dyes, basic dyes, and dye formers of basic dyes which are present in an organic base sublimation ink or a water soluble sublimation ink. The inks can also comprise a thickener such as a water soluble colloid or a hydrophobic material and the like, as well as water. The amount of dye used in the sublimation ink is determined by the depth of shade required for the particular printing.

Suitable sublimation inks for use herein are described in U.S. Pat. No. 4,058,644. However, any sublimation ink may be used. Exemplary of such inks are those containing dyes such as CI #54 Latyl 3G (yellow), CI #25 Latyl NST (orange), CI #1 acetamine B (red), CI #28 Latyl 2R(B) and CI #2 Latyl MS (brown), each of which is available from E. I. Dupont Company.

Examples of commercially available sublimation inks include the sinvatherm line of inks including NW 8380 (blue), NW 6587 (magenta), NW 6586 (yellow), and NW 7814 (black), distributed by Sinclair and Valentine and Company and the Lithotex line of inks such as V-0194 (blue), V-5044 (magenta), V-5008 (yellow), and V-0245 (black), distributed by Colonial Ink Company.

The printing can be applied to the backing sheet using conventional printing techniques, including offset printing, lithographic, photographic, and silk screening techniques. Preferably, in order to achieve the highest possible definition, the images are applied to the backing sheet using the sublimable ink by photographic or lithographic techniques.

Once the printing is formed on the backing sheet, it is transferred to printing receiving layer 20 of floor mat 10 by conventional sublimation techniques, which involve the application of heat along with pressure or vacuum to transfer the sublimation dyes from the backing sheet to printing receiving layer 20.

As illustrated in FIG. 1, when printing receiving layer 20 is printed by sublimation, the printing can be full-bleed printing, that is, it can extend to the border, which is a preferred embodiment of the invention, because of the nature of sublimation printing techniques which permit the backing sheet to be closely aligned with the substrate floor mat 10 for sublimation printing. More importantly, sublimation printing techniques permit the application of high definition printing to printing receiving layer 20 and allow printing in a plurality of colors, including four color process printing (including photographs). By this process very high definition, brilliant printing can be achieved, and it can even be achieved full bleed, on floor mat 10.

The above description is for the purpose of teaching the person of ordinary skill in the art how to practice the present invention, and it is not intended to detail all of those obvious modifications and variations of it which will become apparent to the skilled worker upon reading the description. It is intended however, that all such obvious modifications and variations be included within the scope of the present invention which is defined by the following claims.

What is claimed is:

1. A floor mat comprising:
a top layer comprising a material capable of receiving printing by sublimation printing techniques;
a bottom layer having a floor-contacting surface that resists axial movement of said floor mat on a floor surface; and
at least one adhesive layer between the top and bottom layers;
wherein the top layer includes a four color process printing applied thereon by sublimation of sublimation inks.

2. The floor mat according to claim 1, wherein said material comprising the top layer is a polyester felt material.

3. The floor mat according to claim 1, wherein said bottom layer further comprises a plurality of ridges disposed throughout said floor-contacting surface of the bottom layer for resisting the axial movement of the floor mat on the floor surface.

4. The floor mat according to claim 1, wherein said bottom layer comprises a material having a coefficient of friction that resists the axial movement of the floor mat of the floor surface.

5. The floor mat according to claim 1, wherein said bottom layer comprises a latex foam material.

6. The floor mat according to claim 1, wherein said printing is performed using photographic or lithographic techniques.

7. The floor mat according to claim 1, wherein said printing comprises images, lettering or combinations thereof.

8. The floor mat according to claim 7, wherein said printing is produced full bleed.

9. The floor mat according to claim 1, further comprising an absorbent middle layer placed between said top and bottom layers.

10. The floor mat according to claim 9, further comprising a second adhesive layer, wherein said at least one adhesive layer adheres said top layer to said middle layer and said second adhesive layer adheres said middle layer to said bottom layer.

11. A floor mat comprising:
a top layer comprising a material capable of receiving printing by sublimation printing techniques;
at least one middle layer comprising an absorbent foam material;
a bottom layer comprising a rubber material; and
an adhesive layer between said top and said at least one middle layers and between said at least one middle and said bottom layers;
wherein the top layer includes a four color process printing applied thereon by sublimation of sublimation inks.

12. The floor mat according to claim 10, wherein said bottom layer further comprises a plurality of ridges disposed throughout said floor-contacting surface of the bottom layer to prevent slippage of the floor mat with respect to the floor.

13. The floor mat according to claim 10, wherein said middle layer comprises an open-celled polymeric foam material.

14. The floor mat according to claim 10, wherein said top layer comprises a polyester felt material.

15. The floor mat according to claim 10, wherein said printing is performed using photographic or lithographic techniques.

16. The floor mat according to claim 10, wherein said printing comprises images, lettering or combinations thereof.

17. The floor mat according to claim 16, wherein said printing is produced full bleed.

18. A method for manufacturing a floor mat, comprising the steps of:
providing at top layer comprising a material capable of receiving printing by sublimation printing techniques;
printing an image on a backing sheet using sublimation inks;
transferring the printed image from said backing sheet to said top layer by sublimation of said sublimation inks; and
attaching said top layer to at least one bottom layer using an adhesive;
wherein said bottom layer comprises a floor-contacting surface that resists axial movement of said floor mat on a floor surface.

19. The method for manufacturing the floor mat according to claim 18, further comprising a step of providing a plurality of ridges disposed throughout said floor-contacting surface of the bottom layer for resisting the axial movement of the floor mat on the floor surface.

20. The method for manufacturing the floor mat according to claim 18, further comprising a step of attaching an absorbent middle layer to said top layer and said bottom layer using an adhesive.

21. The method for manufacturing the floor mat according to claim 18, further comprising a step of attaching a slipping layer to a reverse side of the backing sheet to prevent sticking to a sublimation printing apparatus.

22. The method for manufacturing the floor mat according to claim 18, wherein sublimation inks are transferred to the printing receiving layer under heat and pressure.

23. The method for manufacturing the floor mat according to claim 18, wherein said printing is performed using photographic or lithographic techniques.

24. The method for manufacturing the floor mat according to claim 18, wherein said printing comprises images, lettering or combinations thereof.

25. The method for manufacturing the floor mat according to claim 24, wherein said printing is produced full bleed.
